(19) United States
(12) Patent Application Publication
(10) Pub. No.: US 2009/0230710 A1
(43) Pub. Date: Sep. 17, 2009

(54) REAR ACCESSIBLE SERVICE HATCH

(75) Inventors: Jan Cech, Prague (CZ); Karel Vanek, Prague (CZ)

Correspondence Address: WESTMAN CHAMPLIN & KELLY, P.A., SUITE 1400, 900 SECOND AVENUE SOUTH, MINNEAPOLIS, MN, 55402, US

(73) Assignee: CLARK EQUIPMENT COMPANY, West Fargo, ND (US)

(21) Appl. No.: 12/049,059

(22) Filed: Mar. 14, 2008

(51) Int. Cl. B60P 3/00

(52) U.S. Cl. 296/24.3

(57) ABSTRACT

A zero tail swing construction vehicle includes a body, a pair of track assemblies for supporting the body for movement over a surface, an engine supported on the body for providing power, a lower attachment pivotably coupled to the body, an upper attachment pivotably coupled to the body, a hydraulic system for providing power to the lower attachment and the upper attachment, an operator support pivotably coupled to the body and a rear hatch coupled to the operator support. The operator support is pivotable from a usage position forward about a horizontal axis to a service position. The rear hatch is pivotable with the operator support from the usage position to the service position. The construction vehicle further includes a plurality of service check points located underneath the operator support in the usage position. In the usage position the rear hatch conceals the service check points, while in the service position service check points are accessible through an opening.

### FIELD OF THE INVENTION

The present invention relates to a components layout arrangement for an excavator.

### SUMMARY

In one embodiment, the invention provides a construction vehicle including a body, a pair of track assemblies for supporting the body for movement over a surface, an engine supported on the body for providing power, a lower attachment pivotably coupled to the body, an upper attachment pivotably coupled to the body, a hydraulic system for providing power to the lower attachment and the upper attachment, an operator support pivotably coupled to the body and a rear hatch coupled to the operator support. The operator support is pivotable from a usage position forward about a horizontal axis to a service position. The rear hatch is pivotable with the operator support from the usage position to the service position. The construction vehicle further includes a plurality of service check points located underneath the operator support in the usage position. In the usage position the rear hatch conceals the service check points, while in the service position service check points are accessible through an opening.

Other aspects of the invention will become apparent by consideration of the detailed description and accompanying drawings.

### BRIEF DESCRIPTION OF THE DRAWINGS

FIG. 1 is a perspective view of an excavator vehicle according to an embodiment of the invention.

FIG. 2 is a rear view of the excavator vehicle of FIG. 1.

FIG. 3 is a side view of the excavator vehicle of FIG. 1 with the hatch in the open position.

FIG. 4 is a rear view of the excavator vehicle of FIG. 3.

FIG. 5 is a rear perspective view of a portion of the excavator vehicle of FIG. 3.

FIG. 6 is a top view of the excavator vehicle of FIG. 5 with the hatch partially removed.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

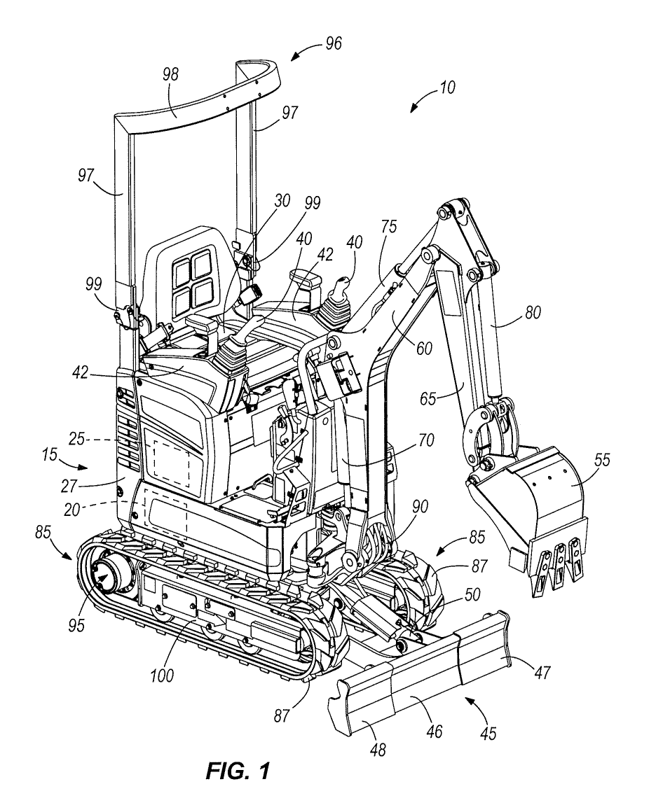

FIG. 1 illustrates an excavator vehicle 10 that is compact and can be referred to as a mini excavator. The illustrated excavator 10 includes a body 15 that encases an engine 20 and a hydraulic system 25. The engine 20 and hydraulic system 25 are operable to provide power and hydraulic fluid to move both the excavator 10 and the attachments. The engine 20 and hydraulic system 25 can be positioned within a mechanicals compartment 27 below an operator support 30. A plurality of operator manipulable controls, such as the illustrated joysticks 40, are positioned adjacent the operator support 30 or armrests 42 and are operable to communicate with the engine 20 and the hydraulic system 25 to control operation of the excavator vehicle 10.

A lower attachment, such as the illustrated dozer blade 45 is pivotably coupled to the body 15. A dozer lift cylinder 50 is coupled between the body 15 and the dozer blade 45 for pivoting the dozer blade 45 with respect to the body 15. The dozer blade 45 is positioned in front of the excavator vehicle 10 to help create a smooth path of travel.

The dozer blade 45 includes a middle portion 46 that is coupled to the frame member 35 and left and rights side portions 47 and 48 that are moveable with respect to the middle portion 46. Left and right actuators (not shown) are coupled between the middle portion 46 and the respective left and right side portions 47 and 48. The dozer blade 45 expands and retracts, such that the dozer blade 45 can be wider than the excavator vehicle 10 if necessary, but can retract to be as narrow as the excavator vehicle 10 to permit travel through narrow openings.

An upper attachment, such as the illustrated bucket 55, is coupled to the body 15 by a boom arm 60 and an attachment arm 65. The boom arm 60 is pivotably coupled to the body 15 and is pivoted relative to the body 15 by a first lift cylinder 70. The attachment arm 65 is pivotably coupled to the boom arm 60 and is pivoted about the boom arm 60 by a second lift cylinder 75. The bucket 55 is pivotable coupled to the attachment arm 65 and is pivoted about the attachment arm 65 by a tilt cylinder 80.

The excavator vehicle 10 further includes left and right track assemblies 85 that are operable to support and move the excavator vehicle 10. The track assemblies 85 each include a track 87 that moves along a surface to move the excavator 10. The track assemblies 85 are driven by the engine 20 and the hydraulic system 25 through a plurality of conduits 90, to provide power to left and right track drive units 95. The track drive units 95 can be motors or any other similar unit that can receive an input of pressurized fluid and generate an output of mechanical movement. The track drive units 95 move left and right tracks assemblies 85 to thereby move the excavator vehicle 10 over a ground surface. The track assemblies 85 can further include a frame plate 100 to at least partially cover the interior of the track assemblies 85 to inhibit entry of debris.

The excavator vehicle 10 can further include a canopy 96 coupled to the body 15 and extending upwardly over the operator support 30. The canopy 96 includes left and right uprights 97 on either side of the operator seat 30 and a cross-member 98 connecting the uprights 97. The canopy 96 can include hinges 99 permitting the uprights 97 to fold down to lower the cross-member 98.

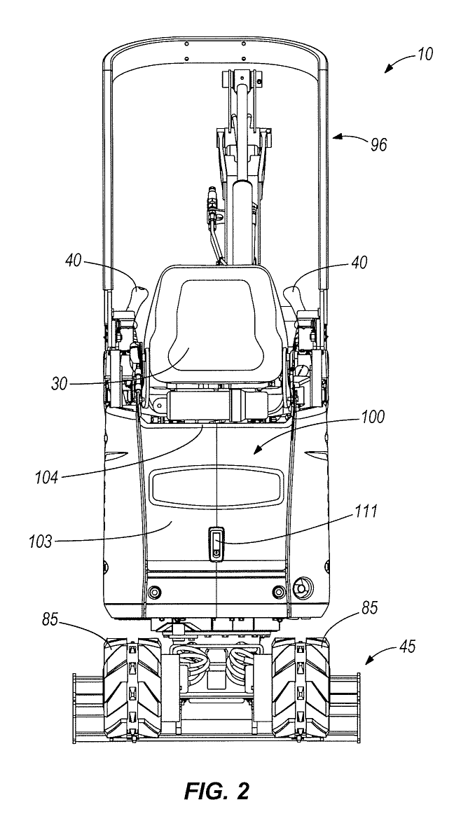

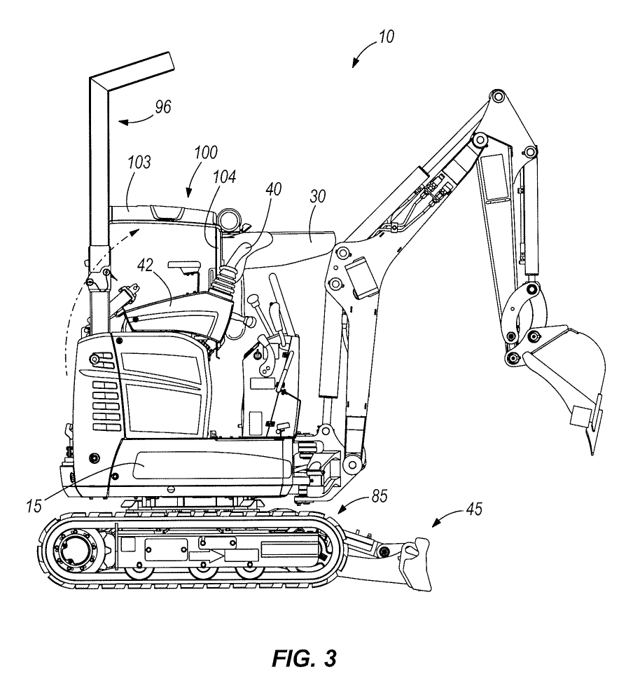

FIG. 2 illustrates the rear of the excavator vehicle 10. An openable hatch 100 is provided on the rear of the excavator vehicle 10 below the operator support 30 for accessing the mechanicals compartment 27. By openable, it is meant that one or more portions of the hatch 100 can be re-positioned to create an opening through which various components shielded by the closed hatch 100 are revealed. FIGS. 3-5 illustrate the hatch 100 in an opened configuration to reveal the opening 102.

In the illustrated embodiment, the hatch 100 includes a rear cover portion 103 and an upper support portion 104. The operator support 30 is positioned above the upper support portion 104 and is mounted to the upper support portion 104. A forward edge 106 of the support portion 104 is pivotally coupled to the body 15 about a horizontal axis 108 at one or more hinges 110. The hatch 100 is pivotable about the axis 108 from a first closed or usage orientation, shown in FIGS. 1 and 2, in which the rear cover portion 103 is vertically oriented and is positioned adjacent to the opening 102 to conceal the opening 102. Also, in the closed orientation, the support portion 104 is horizontally oriented and the operator support 30 is configured for receiving a seated operator thereon. The hatch 100 can be pivoted about the axis 108 forward to a second or service orientation as illustrated in FIGS. 3-5 to reveal the opening 102. In the service orientation, the hatch 100 and the operator support 30 are pivoted forward so that an operator cannot be seated on the operator support 30. The hatch 100 and operator seat 30 can pivot to the service orientation while the armrests 42 and canopy 96 remain stationary. A latch 111 can be provided for securing the hatch 100 in the closed position during operation of the excavator vehicle 10.

A plurality of components are located below the operator support 30 so as to be concealed by the hatch 100 when the hatch 100 is in the closed configuration (see FIG. 2). When the hatch 100 is in the opened configuration, as shown in FIGS. 3-5, various components are visible and/or accessible through the opening 102 for inspection, servicing, repair, replacement, evaluation, etc. Such components are identified herein as “service check points”. The service check points are therefore easily accessible for routine or acute inspection and servicing simply by removing or opening the hatch 100. The service check points are visible from the rear of the vehicle 10. Some service check points can be visible and/or accessible at an approximately vertical plane facing rearwardly and some service check points can be visible and/or accessible at an approximately horizontal plane facing upwardly.

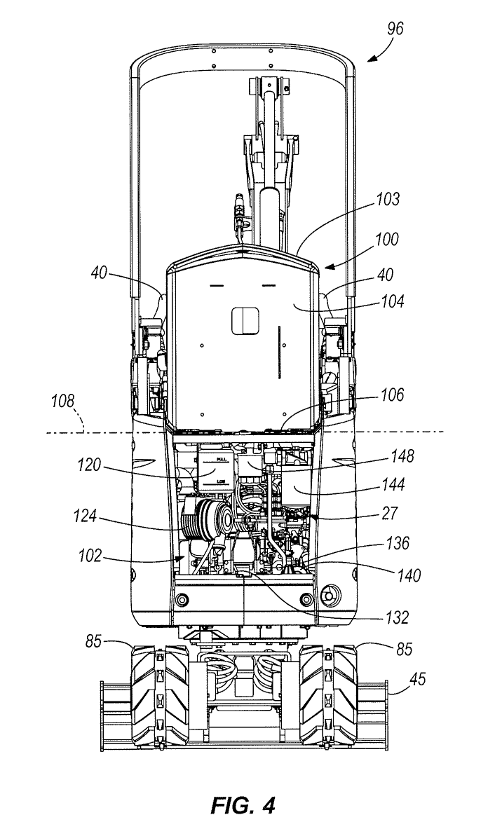

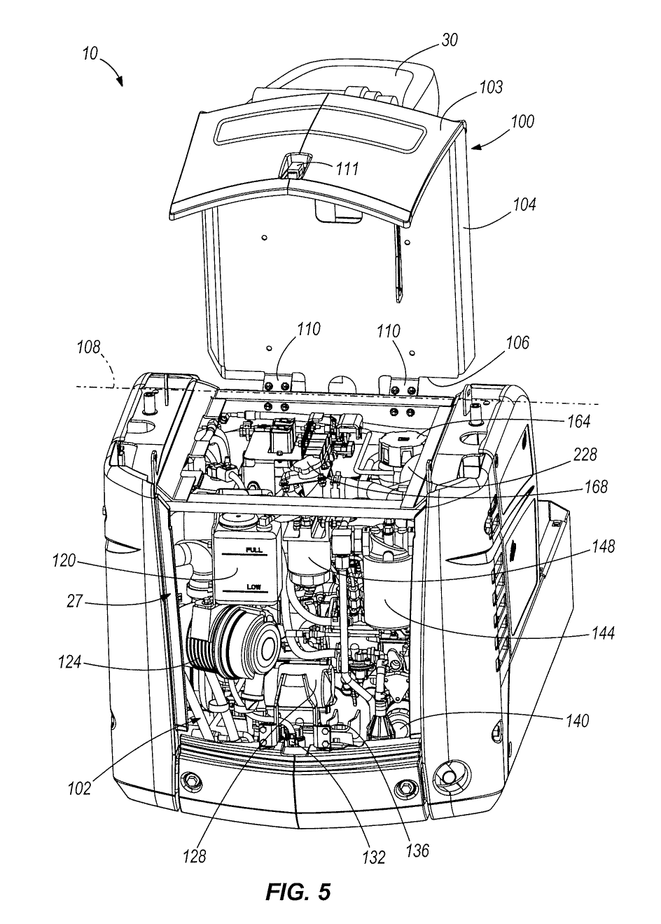

FIG. 4 illustrates service check points that are visible and/or accessible at a rear vertical plane (also shown in FIG. 5). The service check points can include a coolant recovery tank 120, an air filter 124, a starter 128, a hydraulic manifold 132, a fuel hand pump 136, an engine oil filter 140, a hydraulic filter 144 and a fuel filter 148.

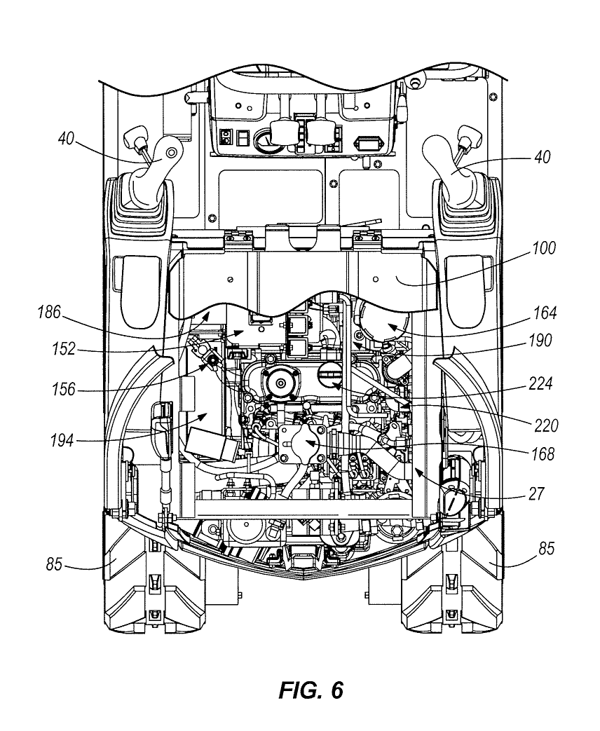

FIG. 6 illustrates service check points that are visible and/or accessible from a horizontal plane facing upwardly. The service check points can also include a fuse and relay box 152, battery contacts 156, a hydraulic oil filling cap 164 and a cooling system cap 168. The service check points can also include an ISO/STD control pattern selector valve 186, an alternator 190, a battery 194, a hydraulic oil cooler and radiator package 220 and an engine oil filling cap 224.

By means of the arrangement illustrated and described, the canopy 96 can be coupled to an upper portion of the body 15. In addition, the excavator 10 can be a zero tail swing vehicle. By zero tail swing, it is meant that the body 15, including the canopy 96, can rotate within the width of the tracks 87. This allows the excavator vehicle 10 to be operated within narrow confines.

Thus, the invention provides, among other things, a rear hatch for accessing service components and/or daily maintenance points that is openable by pivoting the operator seat and the hatch together forward from a usage position. Various features and advantages of the invention are set forth in the following claims.

What is claimed is:

1. A construction vehicle comprising:
a body;
a pair of track assemblies for supporting the body for movement over a surface;
an engine supported on the body for providing power;
a lower attachment pivotably coupled to the body;
an upper attachment pivotably coupled to the body;
a hydraulic system for providing power to the lower attachment and the upper attachment;
an operator support pivotably coupled to the body, the operator support pivotable from a usage position forward about a horizontal axis to a service position;
a plurality of service check points within a mechanicals compartment located underneath the operator support; and
a rear hatch coupled to the operator support, the rear hatch being pivotable with the operator support from the usage position to the service position, wherein in the usage position the rear hatch conceals the service check points and in the service position service check points are accessible through an opening.

2. The construction vehicle of claim 1, wherein the service check points include a coolant recovery tank, an air filter, a starter, a hydraulic manifold, a fuel hand pump an engine oil filter, a hydraulic filter and a fuel filter.

3. The construction vehicle of claim 1, wherein the service check points include a fuse and relay box, battery contacts, a hydraulic oil filling cap, a cooling system cap, an ISO/STD control pattern selector valve, an alternator, a battery, a hydraulic oil cooler and radiator package and an engine oil filling cap.

4. The construction vehicle of claim 1, further comprising a canopy coupled to the body, the canopy including a stationary upright on either side of the operator support.

5. The construction vehicle of claim 1, further comprising an armrest coupled to the body laterally of the operator support.

6. The construction vehicle of claim 1, in which the body is rotatable relative to the track assemblies within a width of the track assemblies.

7. The construction vehicle of claim 1, wherein the rear hatch is substantially vertical in the usage position and substantially horizontal in the service position.

8. The construction vehicle of claim 1, wherein the rear hatch includes a horizontal seat or support position over the mechanicals compartment and a vertical cover extending down a rear side of the mechanicals compartment.

9. The construction vehicle of claim 8, wherein the horizontal support is vertical and the vertical cover is horizontal in the service position.
